(19) United States
(12) Patent Application Publication
(10) Pub. No.: US 2009/0115795 A1
(43) Pub. Date: May 7, 2009

(54) INCREMENTAL BRIGHTNESS COMPENSATION SYSTEMS, DEVICES AND METHODS FOR ORGANIC LIGHT EMITTING DISPLAY (OLED)

(75) Inventors: Han-su Pae, Hwaseong-si (KR); Sang-moo Choi, Yongin-si (KR); Do-hyung Ryu, Seongnam-si (KR)

Correspondence Address: MYERS BIGEL SIBLEY & SAJOVEC, PO BOX 37428, RALEIGH, NC, 27627, US

(73) Assignees: Samsung Electronics Co., Ltd.; Samsung SDI Co., Ltd.

(21) Appl. No.: 12/031,971

(22) Filed: Feb. 15, 2008

(30) Foreign Application Priority Data
Nov. 6, 2007 (KR) 10-2007-0112749

(51) Int. Cl. G09G 5/02

(52) U.S. Cl. 345/589

(57) ABSTRACT

An Organic Light Emitting Display (OLED) includes an array of OLED devices and an incremental OLED brightness compensation system/method. The incremental OLED brightness compensation system/method is configured to incrementally change an electrical supply of the array of OLED devices in response to monitoring a measure of variation between an actual brightness and a desired brightness of the array of OLED devices, so as to cause the OLED to incrementally attain the desired brightness.

### CROSS-REFERENCE TO RELATED APPLICATION

This application claims priority under 35 USC §119 to Korean Patent Application No. 10-2007-0112749, filed on Nov. 6, 2007, the disclosure of which is hereby incorporated herein by reference in its entirety as if set forth fully herein.

### FIELD OF THE INVENTION

This invention relates to flat panel display systems, devices and methods, and more particularly, to Organic Light Emitting Display (OLED) systems, devices, and methods.

### BACKGROUND OF THE INVENTION

OLEDs are widely being investigated and used for many flat panel display applications. As is well known to those having skill in the art, OLEDs are solid state devices that include thin films of organic molecules that create light upon the application of electricity. OLEDs can provide brighter, crisper displays on electronic devices and can use less power than conventional light emitting diodes (LEDs) or liquid crystal displays (LCDs). In general, OLEDs emit light in a similar manner to LEDs, through a process called electrophosphorescence, wherein the OLED emits light in response to current that passes through the organic layer(s). OLEDs therefore are diodes that self-emit light and generally are current driven. OLEDs may be fabricated using passive matrix or active matrix devices and may be configured to provide an array of pixels. Analog and/or digital OLED operation may be provided.

It may also be desirable to provide brightness compensation, systems, devices, and methods for OLEDs. In particular, the brightness of an OLED may vary as a function of temperature. Thus, if the temperature increases, the electrical resistance of the OLED decreases so that the current increases and the brightness increases, and vice versa. Moreover, brightness variation among panels and OLED process lots may produce variation in the OLED's current-voltage (I-V) characteristic. Accordingly, it may be desirable to provide compensation for brightness variation caused by temperature, OLED process variations, and/or other effects.

Brightness compensation may be provided by monitoring one or more OLED devices. The OLED device that is monitored may be a separate monitoring cell outside the display pixels, as described, for example, in U.S. Pat. No. 6,414,443 to Tsuruoka et al. and U.S. Pat. No. 6,788,003 to Inukai et al. Alternatively, a subset of the actual display pixels may be monitored as described in Japanese Publication Application No. JP2004-205704 to Morosawa. Moreover, monitoring may take place by monitoring a current of a monitored OLED device to control the OLED as described, for example, in the above-cited U.S. Pat. Nos. 6,414,443 and 6,788,003. Alternatively, a voltage through a monitored OLED device may be used to control the OLED as described, for example in the above-cited Japanese Published Application No. JP2004-205704. Also note a reference by Miyake et al., entitled “P5: A Voltage Driving AMOLED Display with Luminance Control”, SID Symposium Digest of Technical Papers, 36(1):240-243, May 2005.

### SUMMARY OF THE INVENTION

Some embodiments of the present invention provide an OLED that includes an array of OLED devices and an incremental OLED brightness compensation system. The incremental OLED brightness compensation system is configured to incrementally change an electrical supply of the array of OLED devices in response to monitoring a measure of variation between an actual brightness and a desired brightness of the array of OLED devices, so as to cause the OLED to incrementally attain the desired brightness. In some embodiments, the incremental OLED brightness compensation system is configured to repeatedly incrementally change the electrical supply of the array of OLED devices by less than a full amount that would cause the OLED display to attain the desired brightness and to then change the electrical supply of the array of OLED devices by an amount that causes the OLED display to attain the desired brightness.

In some embodiments, the incremental OLED brightness compensation system is configured to incrementally change a voltage supply of the array of OLED devices in response to monitoring variation between the voltage supply and a voltage produced by at least one of the OLED devices in response to a predetermined current supplied thereto. In some of these embodiments, the incremental OLED brightness compensation system may include a current source, a comparator and a controller. The current source is configured to supply the predetermined current to the at least one OLED. The comparator is configured to produce an UP, DOWN or HOLD signal responsive to a difference between the voltage supply and the voltage produced by the at least one OLED in response to the predetermined current supplied thereto by the current source. The controller is configured to incrementally increase, incrementally decrease or leave unchanged the voltage supply in response to the UP, DOWN or HOLD signal respectively.

In other embodiments, the controller itself may include a Digital-to-Analog Converter (DAC) and a voltage generator. The DAC is responsive to the comparator and is configured to incrementally increase, incrementally decrease or leave unchanged an analog output of the DAC in response to the UP, DOWN or HOLD signal, respectively. The voltage generator is configured to generate the voltage supply of the array of OLED devices in response to the analog output of the DAC. In other embodiments, the controller may include a timing controller that is responsive to the comparator, wherein the DAC is responsive to the timing controller. The timing controller may be responsive to the comparator to increase the DAC input by one in response to the UP signal, to decrease the DAC input by one in response to the DOWN signal, and to leave the DAC input unchanged in response to the HOLD signal.

In still other embodiments, the incremental OLED brightness compensation system is configured to incrementally change the electrical supply of the array of OLED devices during a compensation period of the OLED in response to monitoring a measure of a variation between the measure of the actual brightness and the desired brightness of the array of OLED devices during the compensation period of the OLED, and to maintain the incrementally changed electrical supply during an operational period of the OLED. In some embodiments, the compensation period may occur once for a plurality of frames of the OLED.

Moreover, in some embodiments, the array of OLED devices comprises an array of OLED display pixels and the at least one of the OLED devices comprises at least one of the OLED display pixels. In other embodiments, the at least one of the OLED devices is separate from the array of OLED display pixels.

Other embodiments of the present invention provide controllers for OLEDs that include an array of OLED devices and an electrical supply that is configured to supply a predetermined voltage and/or current to the array of OLED devices. These controllers comprise a comparator and an electrical supply controller. The comparator is configured to produce an UP, DOWN or HOLD signal responsive to a difference between the predetermined voltage and/or current and a monitored voltage and/or current of at least one of the OLED devices. The electrical supply controller is configured to incrementally increase, incrementally decrease or leave unchanged the electrical supply in response to the UP, DOWN or HOLD signal, respectively. The electrical supply controller may include a digital-to-analog converter and/or a timing controller as was already described above, and the comparator and/or electrical supply may operate as was described above.

Embodiments of the present invention have been described above in connection with OLEDs and controllers for OLEDs. However, other embodiments of the present invention can provide brightness compensation methods for OLEDs that comprise incrementally changing an electrical supply of the array of OLED devices in response to monitoring a measure of variation between an actual brightness and a desired brightness of the array of OLED devices, so as to cause the OLED to incrementally attain the desired brightness.

In some method embodiments, the electrical supply of the array of OLED devices is incrementally changed by supplying a predetermined voltage and/or current to the array of OLED devices, by producing an UP, DOWN or HOLD signal responsive to a difference between the predetermined voltage and/or current and a monitored voltage and/or current of at least one of the OLED devices and by incrementally increasing, incrementally decreasing, or leaving unchanged the electrical supply in response to the UP, DOWN or HOLD signal, respectively. A digital-to-analog converter and/or comparator may be used as was described above.

### BRIEF DESCRIPTION OF THE DRAWINGS

FIG. 1 is a block diagram of OLEDs, OLED controllers and methods of operating OLEDs according to various embodiments of the present invention.

FIG. 2 graphically illustrates operation of an incremental OLED brightness compensation system/method according to various embodiments of the present invention.

FIG. 3 is a block diagram of incremental OLED brightness compensation systems/methods according to various embodiments of the present invention.

FIG. 4 is a block diagram of controllers of FIG. 3 according to some embodiments of the present invention.

FIG. 5 is a block diagram of other controllers according to other embodiments of the present invention.

FIG. 6 is a flowchart of operations that may be performed to provide incremental brightness compensation according to various embodiments of the present invention.

FIG. 7 is a block diagram of other embodiments of incremental OLED brightness compensation systems/methods according to other embodiments of the present invention.

FIGS. 8-12 are block diagrams of systems/methods for incremental OLED brightness compensation according to still other embodiments of the present invention.

FIGS. 13A and 13B are timing diagrams that illustrate incremental OLED brightness compensation according to other embodiments of the present invention.

FIGS. 14 and 15 are block diagrams of systems/methods for incremental OLED brightness compensation according to yet other embodiments of the present invention.

### DETAILED DESCRIPTION OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when an element is referred to as being “on,” “connected to”, “coupled to” or “responsive to” another element (and variants thereof), it can be directly on, connected, coupled or responsive to the other element or intervening elements may be present. In contrast, when an element is referred to as being “directly on,” “directly connected to”, “directly coupled to” or “directly responsive to” another element (and variants thereof), there are no intervening elements present. Like reference numerals refer to like elements throughout. As used herein, the term “and/or” includes any and all combinations of one or more of the associated listed items and may be abbreviated as “/”.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes,” “including” and variants thereof, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It also will be understood that, as used herein, the terms “row” or “horizontal” and “column” or “vertical” indicate two relative non-parallel directions that may be orthogonal to one another. However, these terms also are intended to encompass different orientations.

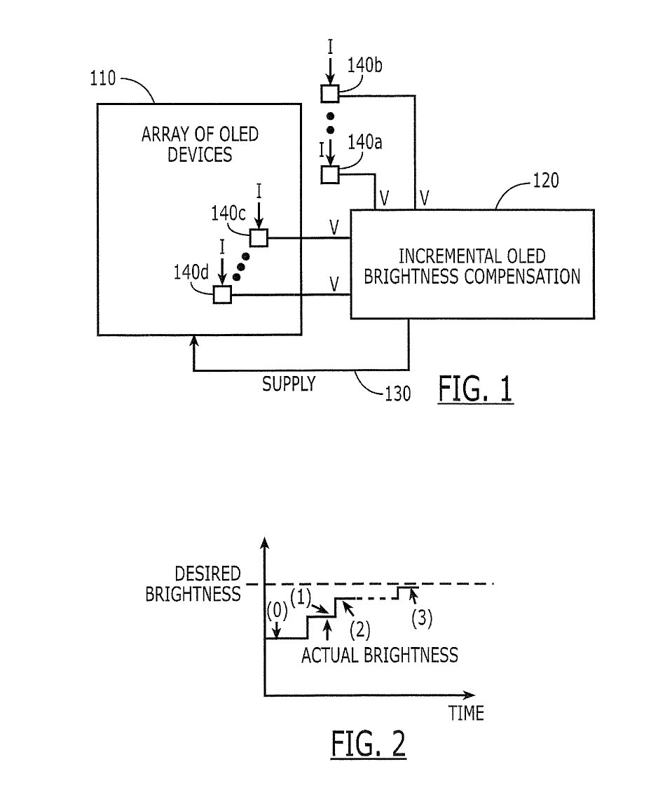

FIG. 1 is a block diagram of OLEDs, OLED controllers for OLEDs and methods of operating OLEDs according to various embodiments of the present invention. Referring now to FIG. 1, an array of OLED devices 110 is provided. Any conventional array of OLED devices 110 that is known or developed hereafter may be used. An incremental OLED brightness compensation system and/or method 120 is also provided. The incremental OLED brightness compensation 120 is configured to incrementally change an electrical supply 130 of the array of OLED devices 110 in response to monitoring a measure of variation between an actual brightness and a desired brightness of the array of OLED devices, so as to cause the OLED to incrementally attain the desired brightness. As used herein, “incrementally” means that the desired brightness is not attained in one step but, rather, one or more intermediate levels of brightness are attained in changing from an actual brightness to a desired brightness.

As shown in FIG. 1, the measure of variation between an actual brightness and a desired brightness may be obtained using one or more monitoring OLED devices. The monitoring OLED devices may be located outside the array of OLED devices 110 as shown by monitoring OLED devices 140a, 140b, and/or may be located at one or more positions within the array of OLED devices 110, as shown by monitoring OLED devices 140c, 140d. Fewer or more monitoring OLED devices may be used.

More specifically, in some embodiments, the incremental OLED brightness compensation system/method 120 is configured to incrementally change the voltage supply 130 of the array of OLED devices 110 in response to monitoring variation between the voltage supply 130 and a voltage V produced by at least one of the monitoring OLED devices 140a-140d, in response to a predetermined current I applied thereto. In other embodiments of the invention, an electrical supply 130 of the array of OLED devices may be configured to incrementally change in response to monitoring variation between the electrical supply 130 and a current produced by at least one of the OLED devices 140a-140d in response to a predetermined voltage applied thereto. Combinations of voltage and current may also be supplied and/or monitored.

FIG. 2 graphically illustrates operation of an incremental OLED brightness compensation system/method, such as the incremental OLED brightness compensation system/method 120 of FIG. 1, according to various embodiments of the present invention. As shown in FIG. 2, the actual brightness (solid line) is incrementally changed to attain the desired brightness (dashed line), rather than changing the actual brightness to the desired brightness in one step. By incrementally changing an electrical supply of the array of OLED devices in response to monitoring a variation between the actual brightness and the desired brightness, rapid changes in brightness, which may be visible to the user, can be avoided or reduced. The incremental or gradual change may be less visible to the user while still allowing the OLED to attain its desired brightness within a reasonable time frame.

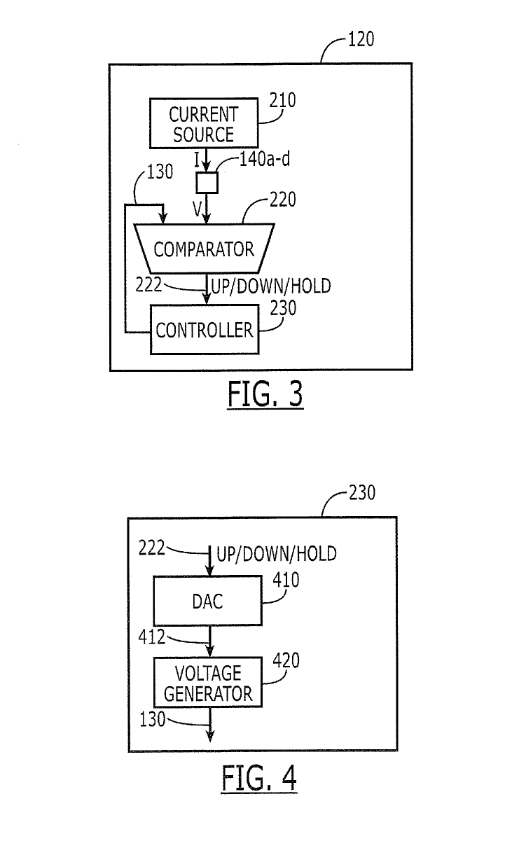

FIG. 3 is a block diagram of incremental OLED brightness compensation systems/methods according to various embodiments of the present invention, which may correspond to Block 120 of FIG. 1. As shown in FIG. 3, a current source 210 is configured to supply the predetermined current I to the at least one OLED 140a-140d. A comparator 220 is configured to produce an UP, DOWN or HOLD signal 222 responsive to a difference between the voltage supply 130 and the voltage V produced by the at least one OLED 140a-140d in response to the predetermined current I supplied thereto by the current source 210. A controller 230 is configured to incrementally increase, incrementally decrease or leave unchanged, the voltage supply in response to the UP, DOWN or HOLD signal 222, respectively.

FIG. 4 is a block diagram of controllers 230 of FIG. 3 according to some embodiments of the present invention. As shown in FIG. 4, these controllers 230 may include a Digital-to-Analog Converter (DAC) 410 that is responsive to the comparator 220 and that is configured to incrementally increase, incrementally decrease or leave unchanged an analog output 412 thereof in response to the UP, DOWN, or HOLD signal 222, respectively. A voltage generator 420 is configured to generate the voltage supply 130 of the array of OLED devices 110 in response to the analog output of the DAC 410.

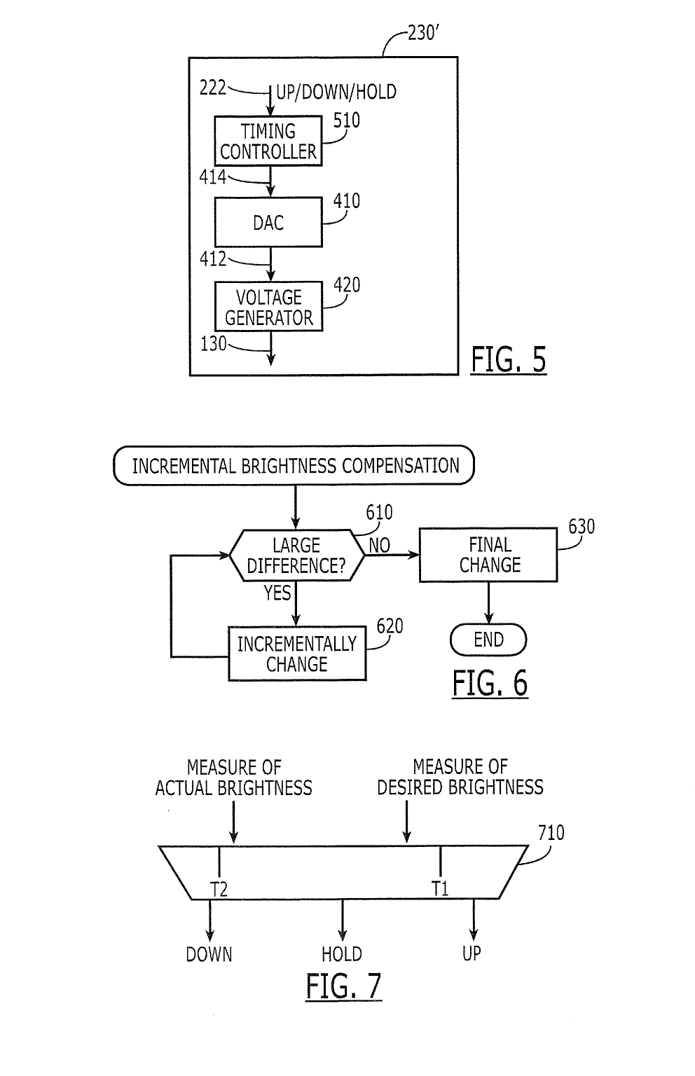

FIG. 5 is a block diagram of a controller 230′ according to other embodiments of the present invention. In these embodiments, a timing controller 510 is provided that is responsive to the comparator 220, and a DAC 410 is responsive to the timing controller 510. The timing controller 510 is responsive to the comparator 220 to increase the DAC input 414 by one in response to the UP signal, to decrease the DAC input 414 by one in response to the DOWN signal, and to leave the DAC input 414 unchanged in response to the HOLD signal.

FIG. 6 is a flowchart of operations that may be performed to provide incremental brightness compensation according to various embodiments of the present invention. These operations may be performed by the incremental OLED brightness compensation system/method 120 of FIG. 1. These operations may be explained by again referring to the graph of FIG. 2. Referring now to FIGS. 2 and 6, at Block 610, if a large difference is present between the desired brightness and the actual brightness as shown at time (0) of FIG. 2, then the electrical supply 130 of the array of OLED devices 110 is incrementally changed at Block 620 by less than a full amount that would cause the OLED to attain the desired brightness, as shown at time (1) of FIG. 2. If the large difference still exists at Block 610, then another increment is performed at Block 620, as shown at time (2) of FIG. 2. Finally, as shown at time (3) of FIG. 2, when the large difference is no longer present at Block 610, a final change is performed at Block 630 to change the electrical supply of OLED by an amount that causes the OLED to attain the desired brightness.

FIG. 7 illustrates other embodiments of incremental OLED brightness compensation systems and methods according to other embodiments of the present invention, which may correspond to Block 120 of FIG. 1. In these embodiments, a comparator 710 is provided that functionally operates to compare the measure of actual brightness and the measure of the desired brightness relative to first and second thresholds T1 and T2. These thresholds may be the same in absolute value or different in absolute value. The comparator is configured to produce the UP signal when the measure of the variation of the actual brightness and the desired brightness exceeds a first threshold T1, to produce the DOWN signal when the measure of the variation of the actual brightness and the desired brightness is less than a second threshold T2 and to produce the HOLD signal when the measure of variation of the actual brightness and the desired brightness is between the first threshold T1 and the second threshold T2.

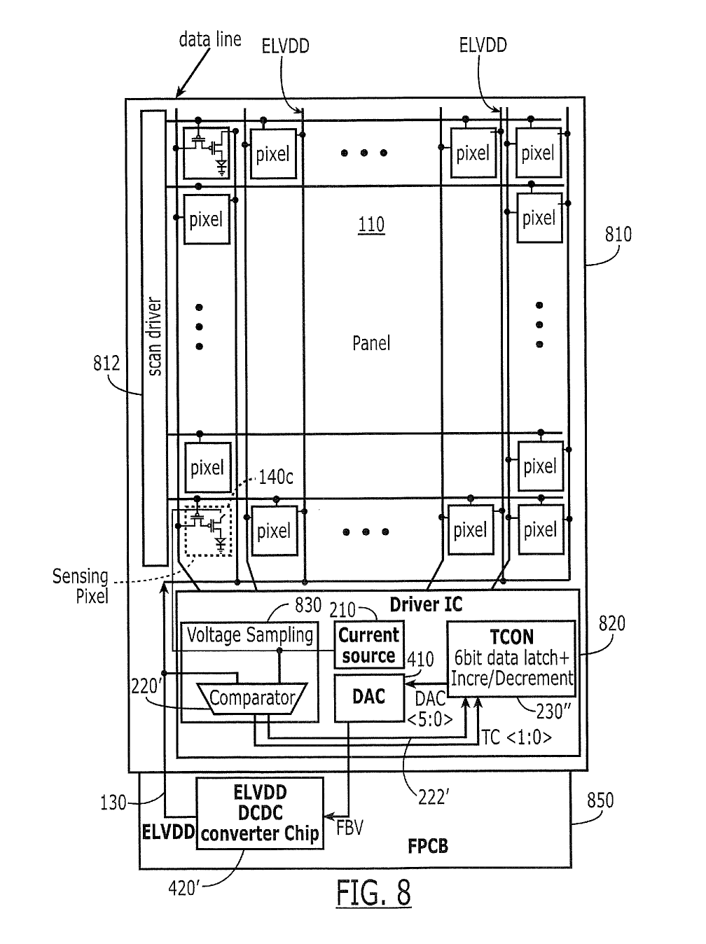

FIG. 8 is a block diagram of systems and/or methods for incremental OLED brightness compensation according to still other embodiments of the present invention. As shown in FIG. 8, an OLED panel substrate 810 includes thereon an array of OLED devices 110 that provide a plurality of pixels for the OLED. A scan driver 812 drives a plurality of scan lines and a driver integrated circuit (IC) 820, also referred to as a “control block”, drives a plurality of data lines. In embodiments of FIG. 8, the control block 820 may include an incremental OLED brightness compensation system/method according to various embodiments of the invention, as will now be described.

More specifically, a sensing pixel 140c is provided. In embodiments of FIG. 8, the sensing pixel 140c is selected from the array of OLED devices 110 and is located at the bottom left corner of the array of OLED devices 110. However, in other embodiments, multiple sensing pixels may be employed at various locations in the array of OLED display devices and/or one or more sensing pixels may be provided separate from the array of OLED display devices. In particular, OLED materials are generally evaporated on a substrate. Accordingly, the thickness may vary at various locations of the panel. Thus, multiple sensing pixels may be used in some embodiments or a representative pixel may be used.

Still referring to FIG. 8, a current source 210 is provided to energize the sensing pixel 140c with a predetermined current. The current source 210 may be disconnected from the sensing pixel 140c when it is not being used, via, for example, a switch as shown in the sensing pixel 140c or located elsewhere. Moreover, a voltage sampling circuit 830 may be provided that includes a comparator 220′ that is configured to compare the voltage that is produced by the sensing OLED device 140c in response to the predetermined current supplied thereto by the current source 210, to the voltage supply 130 of the array of OLED devices, referred to herein as ELVDD. The comparator 220′ is configured to provide a two-bit signal TC to a timing controller TCON 230″ which in turn provides an input signal to a DAC 410. The DAC 410 provides a feedback voltage FBV to a DC-to-DC converter chip 420′ that generates the power supply voltage ELVDD. The DC-to-DC converter chip 420′ may be located on a Flexible Printed Circuit Board (FPCB) 850 in some embodiments.

Detailed operation of embodiments of FIG. 8 will now be provided. In particular, the current source 210 may be configured to source a current that is the same as an emitting current that is set for a desired panel brightness. This current may be determined during the manufacture of the OLED based on a desired brightness and/or may be set thereafter by a user using a menu on the OLED. The predetermined current level may be determined by the target panel luminance and the OLED luminance-versus-current (L-I) characteristics, which can change as a result of the OLED manufacturing process.

In order to adjust the current level, the driver IC 820 may include nonvolatile memory in which the target level is stored as a digital value. This digital value may be set during manufacturing and/or by a user. In any event, the predetermined current that is provided by the current source 210 corresponds to a desired brightness for the OLED. This current is provided by the driver IC 820 to the sensing pixel 140c and causes the sensing pixel 140c to produce a diode voltage. This diode voltage may change due to temperature effects, OLED manufacturing process variations and/or other effects. This voltage is sensed in the voltage sampling circuit 830 by the comparator 220′ and compared to the power supply voltage ELVDD that is provided to the array of OLED devices 110.

In embodiments of FIG. 8, the compared result 222′ provides a two-bit signal. Thus, the signal TC may provide an UP, DOWN or HOLD signal 222′ responsive to a difference between the voltage supply ELVDD and the voltage produced by the at least one OLED 140c in response to the predetermined current supplied thereto by the current source 210. The UP signal may be provided when the difference between the sampled voltage and the power supply voltage exceeds a first threshold. The DOWN signal may be provided when the difference is less than a second threshold and the HOLD signal may be provided when the difference is between the first and second thresholds. A specific example will be provided below. It will also be understood that the two thresholds may be negatives of one another (i.e., same absolute value) or may be of different magnitudes. It will also be understood that more than two thresholds may be provided in other embodiments of the present invention.

Continuing with the description of FIG. 8, the UP, DOWN, or HOLD signal 222′ may be provided by the comparator 220′ to a timing controller 230″ as a two-bit signal TC or by using larger numbers of bits and/or separate signal lines for each signal. The timing controller TCON 230″ is configured to drive the DAC 410, for example, with a six-bit signal that signifies a digital input to the DAC 410. It will be understood that more than six bits or fewer than six bits may be used in other embodiments. The DAC 410 then provides a feedback voltage FBV to the power supply voltage generator 420′ referred to in FIG. 8 as an “ELVDD DCDC converter chip”. The power supply voltage ELVDD is generated by the voltage generator 420′ in response to the feedback voltage FBV that is supplied as an input thereto. The voltage generator 420′ may be configured to provide an ELVDD based on the following equation:

ELVDD=α×FBV+β

where α is a multiplier and β is an offset. The multiplier a may be a function of the gain of the comparator 220′, whereas the offset β may be selected so that the proper ELVDD voltage is provided without the need to use an input voltage FBV that is outside the range of the converter chip 420′. Stated differently, the driver IC 820 may be a low voltage device but the converter chip 420′ may need to generate a higher voltage. The gain α and/or offset β may therefore be selected so that an appropriate feedback voltage FBV may be provided by DAC 410 to drive the voltage generator 420′ to provide a desired power supply voltage ELVDD. The driver IC 820 may therefore use voltages within its range while still allowing the voltage generator 420′ to controllably provide a high voltage. The voltage generator 420′ may be located on the FPCB 850.

The following Table illustrates how the comparator may provide UP, DOWN, and HOLD signals based on the value of the output of the two-bit signal TC 222′ provided by the comparator 220′. As shown in the Table, a value of 0:0 signifies DOWN, a value of 1:1 signifies UP, and a value of 0:1 or 1:0 signifies HOLD.

TABLE

| TC<1> | TC<0> | TCON ACTION |
|---|---|---|
| 0 | 0 | DOWN |
| 0 | 1 | HOLD |
| 1 | 0 | HOLD |
| 1 | 1 | UP |

Continuing with the illustration of the above Table, the timing controller 230″ then drives the DAC 410 by increasing the DAC input by one in response to the UP signal, decreasing the DAC input by one in response to the DOWN signal, and leaving the DAC input unchanged in response to the HOLD signal. Thus, operation of the comparator 220′ and the timing controller 230″ may have the following effect on the input to the DAC 410:

IF Vsamp > ELVDD + Vmargin
→TC<1:0>=<1:1> → DAC<5:0>=1 bit higher
→FBV higher → ELVDD higher
IF Vsamp < ELVDD − Vmargin
→TC<1:0>=<0:0> → DAC<5:0>=1 bit lower
→FBV lower → ELVDD lower
IF ELVDD − Vmargin < Vsamp < ELVDD + Vmargin
→TC<1:0>=<1:0> or <0:1> → No change;

where Vsamp is the voltage sample by the voltage sampling Block 830 and Vmargin corresponds to a threshold voltage that may be determined by the characteristics of the comparator 220′ (i.e., the margins of the comparator), by setting a value in a lookup table of the timing controller 230″ and/or by other techniques. Moreover, as was described above, in other embodiments, more than two thresholds may be provided. For example, if there are three thresholds, four different steps may be obtained corresponding to, for example, two bits UP, two bits DOWN, one bit UP and one bit DOWN. Other larger or smaller numbers of thresholds may be provided.

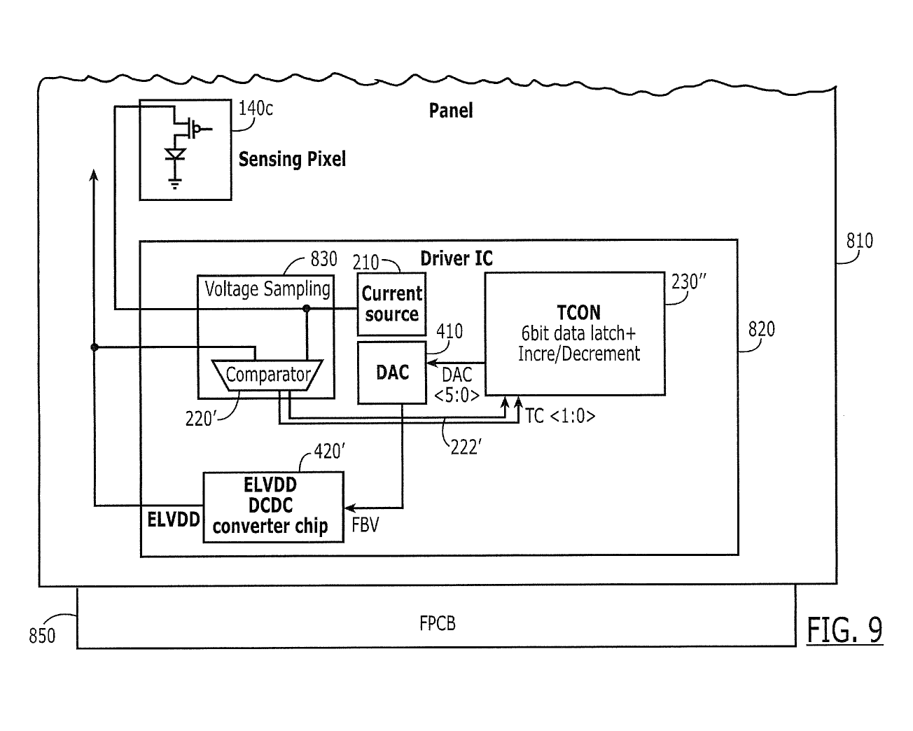

FIG. 9 is a block diagram of other embodiments of the present invention showing the bottom portion of the panel 810. In these embodiments, the voltage generator 420′ is located in the driver IC 820. In this case, the power supply voltage ELVDD may be provided by the equation: ELVDD=FBV+ΔV, such that a multiplier may need not be provided. However, in embodiments of FIG. 9, the driver IC 820 may need to provide a high voltage capacity.

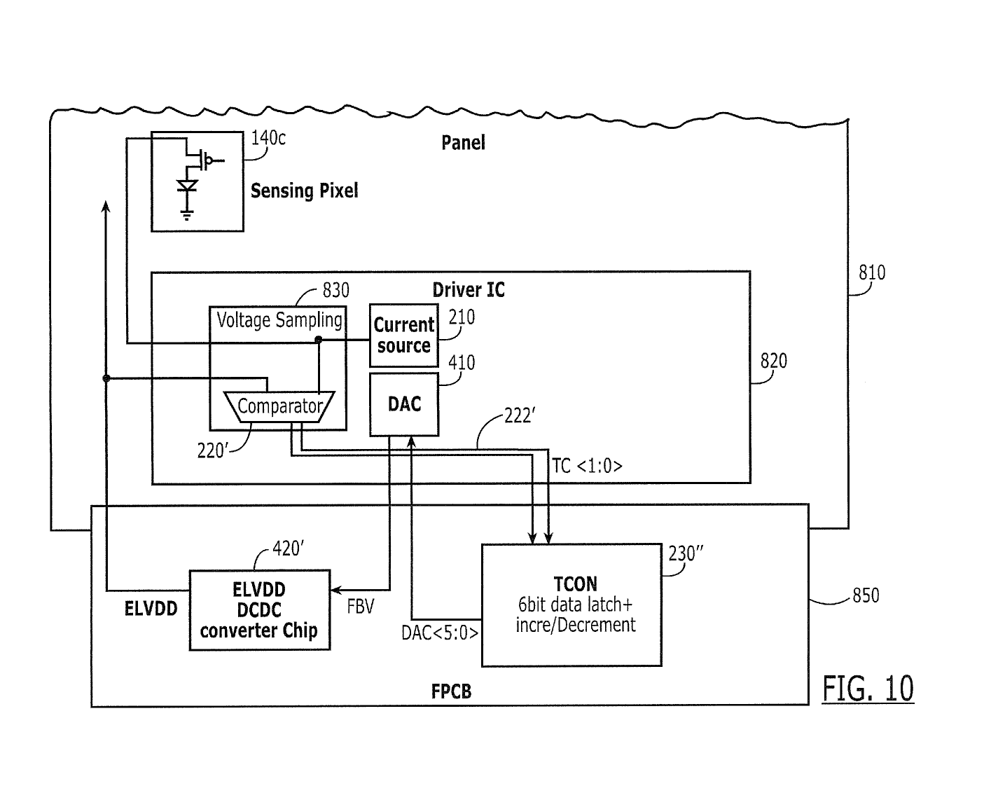

FIG. 10 illustrates yet other embodiments of the present invention where the timing controller 230″ is also located outside of the driver IC 820, for example on FPCB 850. These embodiments may be particularly useful for large size panel applications.

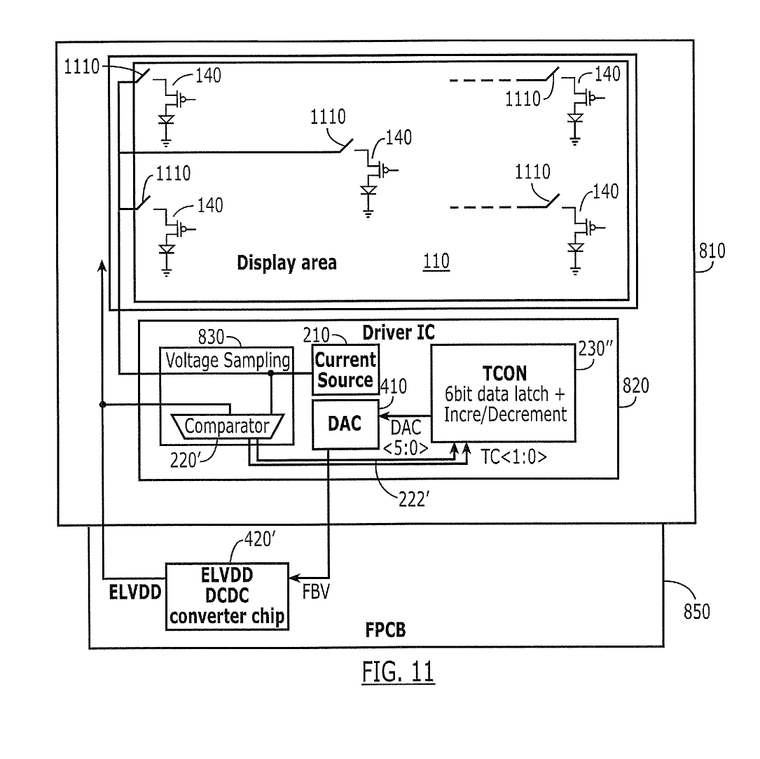

FIG. 11 is a block diagram of other embodiments of the present invention. In these embodiments, a plurality of the OLED display pixels are used as a sensing pixel 140. In FIG. 11, a sensing pixel 140 at each of the corners and in the center of the OLED is illustrated. However, fewer or more pixels may be used and/or different locations may be used. In some embodiments, the sensing pixels may be activated serially to monitor the OLED device. Sequential selection may be provided using a switch 1110 that is associated with each sensing pixel 140. In some embodiments, the pixels may be selected and sensed sequentially, and then an average value may be used to compare with ELVDD. In other embodiments, the sensing pixels 140 can be selected to find the sensing pixel 140 that is most representative of the array of OLED devices. In still other embodiments, the voltages may be sensed in parallel. It will also be understood that the switches 1100 may be located on the display panel 810, in the driver IC 820 and/or elsewhere. Finally, in still other embodiments in an RGB display, the switches 1110 may be used to allow independent sensing of the red, green, and blue brightnesses.

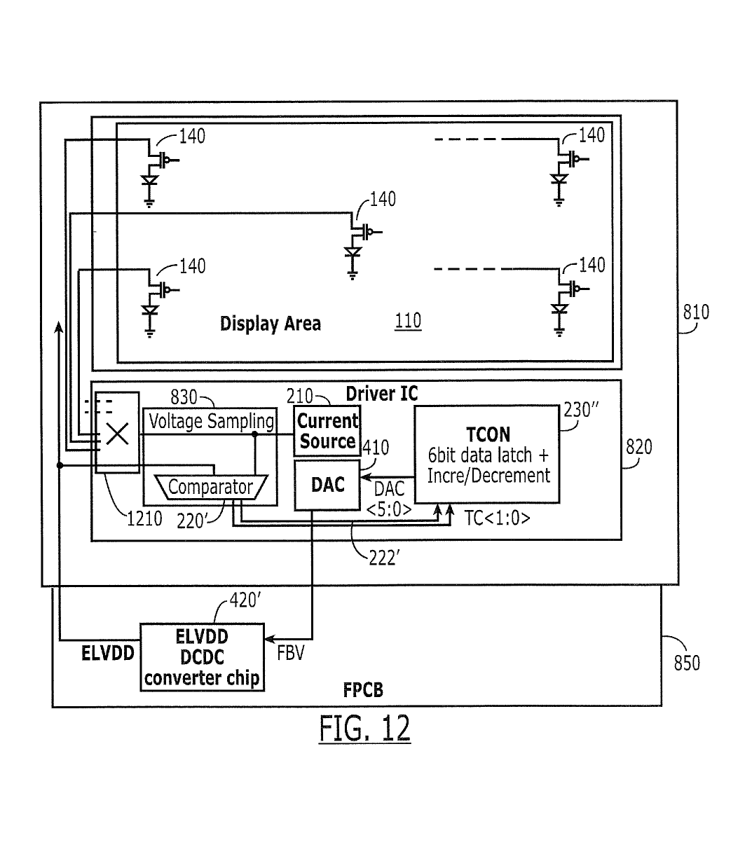

FIG. 12 illustrates other embodiments of the invention that use a multiplexer 1210 rather than the switches 1110 of FIG. 11 to select one or more of the sensing OLED devices 140.

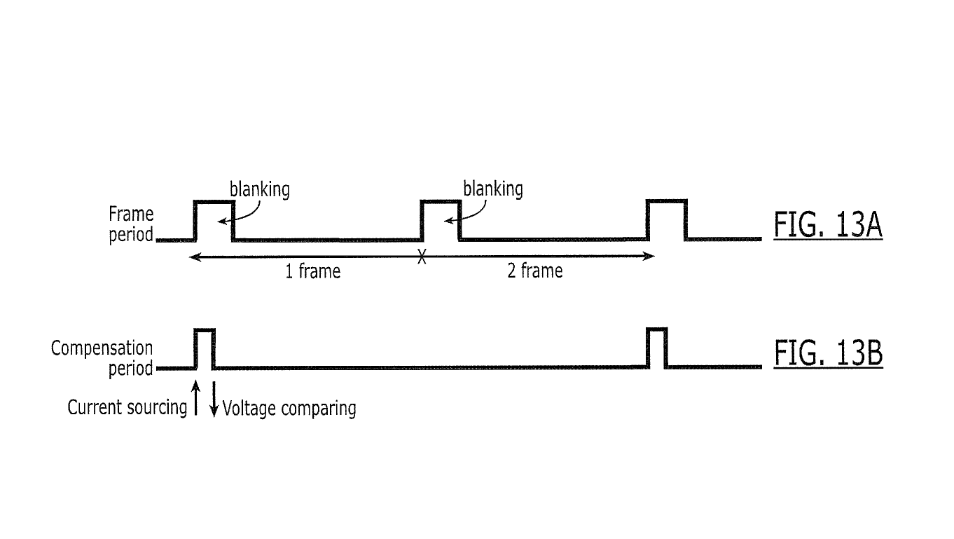

FIGS. 13A and 13B are timing diagrams that illustrate incremental OLED brightness compensation according to other embodiments of the present invention. FIG. 13A illustrates conventional operation of an OLED using frames. As is well known to those having skill in the art, data for the OLED is refreshed or updated during each successive frame blanking period. In FIG. 13A two frames are shown.

Moreover, as shown in FIG. 13B, compensation is set up during the frame blanking period of FIG. 13A, so that an incremental OLED brightness compensation system/method is configured to incrementally change the electrical supply of the array of OLED devices during a compensation period of the OLED, which may correspond to a blanking period, in response to monitoring a measure of the variation between the actual brightness and the desired brightness of the array of OLED devices during the compensation period of the OLED. The incrementally changed electrical supply is then maintained during an operational period, shown in FIG. 13A as the periods between the blanking periods. In other embodiments, the compensation period of FIG. 13B may occur anywhere in a frame, and in particular, at least partially outside the blanking period. In fact, since embodiments of the present invention provide incremental OLED brightness compensation systems/methods, additional flexibility may be obtained as to the location of the compensation period, because a display abnormality may not be recognized by a user even during the compensation period.

Moreover, as shown in FIG. 13B, a compensation period need not occur for every frame. Rather, the compensation period may occur once for a plurality of frames of the OLED. In embodiments of FIG. 13B, the compensation period takes place once every two frames. In other embodiments, compensation may occur once every four or more frames. If the compensation period takes place once per frame, a faster ELVDD stabilization may take place. In contrast, if compensation only takes place once for a plurality of frames, slower stabilization may take place, which can provide a smoothing effect. The number of frames per compensation period may be set during manufacture and/or may be selected by a user. Moreover, as was described above, the compensation period may take place anywhere during the given number of frames, according to other embodiments of the present invention.

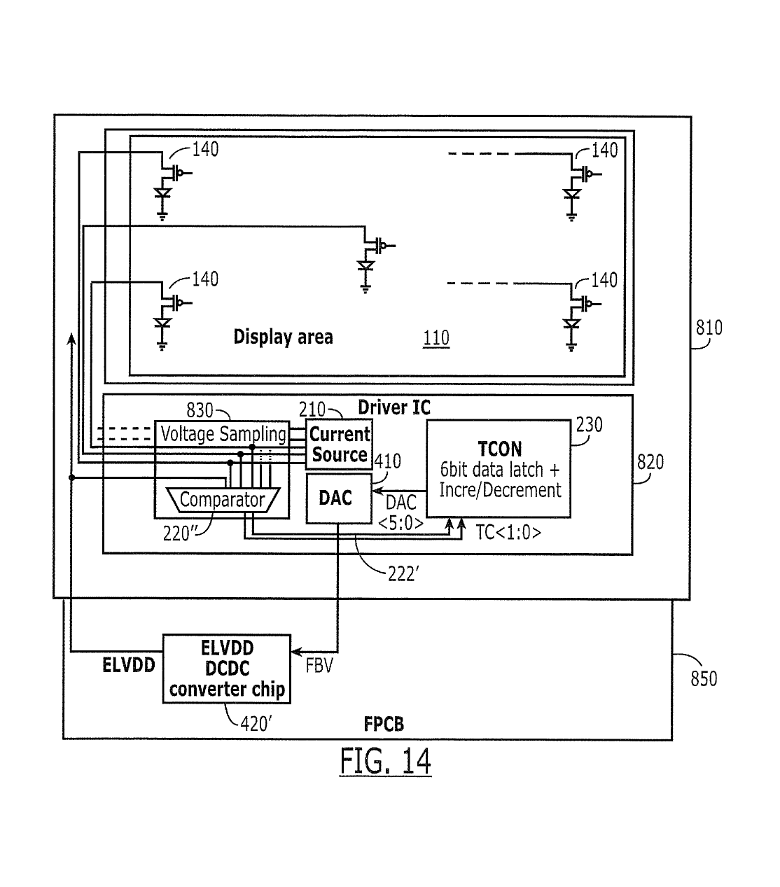

FIG. 14 illustrates other embodiments of the invention where multiple monitoring OLED devices 140 are monitored in parallel. In these embodiments, the comparator 220″ may include an averaging circuit therein so as to compare the average of the sensed voltages to the ELVDD voltage. In other embodiments, the comparator 220″ can output a signal TC that can provide multiple comparisons, rather than an average comparison, to allow greater accuracy, at the potential expense of greater complexity in the comparator 220″.

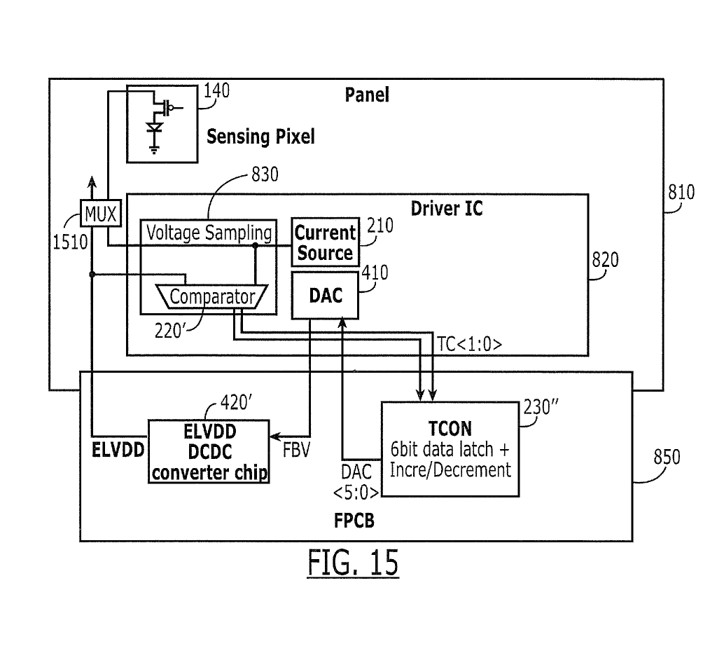

Finally, FIG. 15 illustrates other embodiments of the present invention that add a multiplexer (MUX) 1510 that allows the sensing pixels to switch from a normal operation using ELVDD and a sensing operation wherein current is provided by the current source 210. Other techniques, as illustrated in other embodiments herein, may be used to selectively apply ELVDD or the current from current source 210 to a given sensing pixel. For example, in some embodiments the ELVDD line may be selected in the ELVDD converter chip 420′, and the selection of the current source and voltage sampling may be selected in the driver IC 820. It will be understood that the various embodiments described herein may be combined in various combinations and subcombinations of features.

It will also be understood that many of the embodiments described herein provided a predetermined current and monitored voltage from the sensing pixels. However, other embodiments may provide a predetermined voltage and may monitor the current from the sensing pixels. Moreover, embodiments of the invention have also been described herein without regard to color. However, if there are there separate color subpixels, such as RGB subpixels on a panel, then a sensing pixel for each of the colors may desirably be used. Alternatively, if there is only one color OLED, such as a white OLED with RGB color filters, then only one sensing pixel may need to be used.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. An Organic Light Emitting Display (OLED) comprising:
an array of OLED devices; and
an incremental OLED brightness compensation system that is configured to incrementally change an electrical supply of the array of OLED devices in response to monitoring a measure of variation between an actual brightness and a desired brightness of the array of OLED devices, so as to cause the OLED to incrementally attain the desired brightness.

2. An OLED according to claim 1 wherein the incremental OLED brightness compensation system is configured to incrementally change a voltage supply of the array of OLED devices in response to monitoring variation between the voltage supply and a voltage produced by at least one of the OLED devices in response to a predetermined current supplied thereto.

3. An OLED according to claim 2 wherein the incremental OLED brightness compensation system comprises:
a current source that is configured to supply the predetermined current to the at least one OLED;
a comparator that is configured to produce an UP, DOWN or HOLD signal responsive to a difference between the voltage supply and the voltage produced by the at least one OLED in response to the predetermined current supplied thereto by the current source; and
a controller that is configured to incrementally increase, incrementally decrease or leave unchanged the voltage supply in response to the UP, DOWN or HOLD signal, respectively.

4. An OLED according to claim 3 wherein the controller comprises:
a digital-to-analog converter (DAC) that is responsive to the comparator and that is configured to incrementally increase, incrementally decrease or leave unchanged an analog output of the DAC in response to the UP, DOWN or HOLD signal, respectively; and
a voltage generator that is configured to generate the voltage supply of the array of OLED devices in response to the analog output of the DAC.

5. An OLED according to claim 4 wherein the controller further comprises:
a timing controller that is responsive to the comparator, wherein the DAC is responsive to the timing controller.

6. An OLED according to claim 5 wherein the timing controller is responsive to the comparator to increase the DAC input by one in response to the UP signal, to decrease the DAC input by one in response to the DOWN signal and to leave the DAC input unchanged in response to the HOLD signal.

7. An OLED according to claim 1 wherein the incremental OLED brightness compensation system is configured to repeatedly incrementally change the electrical supply of the array of OLED devices by less than a full amount that would cause the OLED to attain the desired brightness and to then change the electrical supply of the array of OLED devices by an amount that causes the OLED to attain the desired brightness.

8. An OLED according to claim 1 wherein the incremental OLED brightness compensation system is configured to incrementally change the electrical supply of the array of OLED devices during a compensation period of the OLED in response to monitoring a measure of a variation between the actual brightness and the desired brightness of the array of OLED devices during the compensation period of the OLED, and to maintain the incrementally changed electrical supply during an operational period of the OLED.

9. An OLED according to claim 8 wherein the compensation period occurs once for a plurality of frames of the OLED.

10. An OLED according to claim 1 wherein the array of OLED devices comprises an array of OLED display pixels and wherein the at least one of the OLED devices comprises at least one of the OLED display pixels.

11. An OLED according to claim 1 wherein the array of OLED devices comprises an array of OLED display pixels and wherein the at least one of the OLED devices is separate from the array of OLED display pixels.

12. An OLED according to claim 1 wherein the incremental OLED brightness compensation system comprises a comparator that is configured to produce an UP, DOWN or HOLD signal responsive to the measure of variation between the actual brightness and the desired brightness of the array of OLED devices.

13. An OLED according to claim 12 wherein the comparator is configured to produce the UP signal when the measure of variation between the actual brightness and the desired brightness exceeds a first threshold, to produce the DOWN signal when the measure of variation between the actual brightness and the desired brightness is less than a second threshold and to produce the HOLD signal when the measure of variation between the actual brightness and the desired brightness is between the first threshold and the second threshold.

14. A controller for an Organic Light Emitting Display (OLED) that includes an array of OLED devices and an electrical supply that is configured to supply a predetermined voltage and/or current to the array of OLED devices, the controller comprising:
a comparator that is configured to produce an UP, DOWN or HOLD signal responsive to a difference between the predetermined voltage and/or current and a monitored voltage and/or current of at least one of the OLED devices; and
an electrical supply controller that is configured to incrementally increase, incrementally decrease or leave unchanged the electrical supply in response to the UP, DOWN or HOLD signal, respectively.

15. A controller according to claim 14 wherein the electrical supply controller comprises:
a digital-to-analog converter (DAC) that is responsive to the comparator and that is configured to incrementally increase, incrementally decrease or leave unchanged an analog output of the DAC in response to the UP, DOWN or HOLD signal, respectively.

16. A controller according to claim 15 wherein the electrical supply controller further comprises:
a timing controller that is responsive to the comparator, wherein the DAC is responsive to the timing controller.

17. A controller according to claim 16 wherein the timing controller is responsive to the comparator to increase the DAC input by one in response to the UP signal, to decrease the DAC input by one in response to the DOWN signal and to leave the DAC input unchanged in response to the HOLD signal.

18. A controller according to claim 14 wherein the comparator is configured to produce the UP signal when the difference between the predetermined voltage and/or current and a monitored voltage and/or current of at least one of the OLED devices exceeds a first threshold, to produce the DOWN signal when the difference is less than a second threshold and to produce the HOLD signal when the difference is between the first threshold and the second threshold.

19. A brightness compensation method for an Organic Light Emitting Display (OLED) that includes an array of OLED devices, the brightness compensation method comprising:
incrementally changing an electrical supply of the array of OLED devices in response to monitoring a measure of variation between an actual brightness and a desired brightness of the array of OLED devices, so as to cause the OLED to incrementally attain the desired brightness.

20. A method according to claim 19 wherein incrementally changing comprises:
supplying a predetermined voltage and/or current to the array of OLED devices;
producing an UP, DOWN or HOLD signal responsive to a difference between the predetermined voltage and/or current and a monitored voltage and/or current of at least one of the OLED devices; and
incrementally increasing, incrementally decreasing or leaving unchanged the electrical supply in response to the UP, DOWN or HOLD signal, respectively.

21. A method according to claim 20 wherein incrementally increasing, incrementally decreasing or leaving unchanged the electrical supply in response to the UP, DOWN or HOLD signal, respectively, comprises:
incrementally increasing, incrementally decreasing or leaving unchanged an analog output of a digital-to-analog converter (DAC) in response to the UP, DOWN or HOLD signal, respectively; and
incrementally increasing, incrementally decreasing or leaving unchanged the electrical supply in response to the analog output of the DAC.

22. A method according to claim 21 wherein incrementally increasing, incrementally decreasing or leaving unchanged an analog output of a digital-to-analog converter (DAC) in response to the UP, DOWN or HOLD signal, respectively, comprises increasing the DAC input by one in response to the UP signal, decreasing the DAC input by one in response to the DOWN signal and leaving the DAC input unchanged in response to the HOLD signal.

23. A method according to claim 19 wherein incrementally changing an electrical supply of the array of OLED devices in response to monitoring a measure of variation between an actual brightness and a desired brightness of the array of OLED devices is performed repeatedly to repeatedly incrementally change the electrical supply of the array of OLED devices by less than a full amount that would cause the OLED to attain the desired brightness and is followed by changing the electrical supply of the array of OLED devices by an amount that causes the OLED to attain the desired brightness.

24. A method according to claim 19 wherein incrementally changing an electrical supply of the array of OLED devices in response to monitoring a measure of variation between an actual brightness and a desired brightness of the array of OLED devices is preformed during a compensation period of the OLED in response to monitoring a measure of a variation between the actual brightness and the desired brightness of the array of OLED devices during the compensation period of the OLED, and to maintain the incrementally changed electrical supply during an operational period of the OLED.

25. A method according to claim 24 wherein the compensation period occurs once for a plurality of frames of the OLED.
